(19) United States
(12) Patent Application Publication
(10) Pub. No.: US 2022/0365815 A1
(43) Pub. Date: Nov. 17, 2022

(54) SUB-QUEUE INSERTION SCHEMES EXECUTABLE BY QUEUE MANAGERS AND RELATED SYSTEMS AND OPERATIONS

(71) Applicant: ZEKU, INC., PALO ALTO, CA (US)

(72) Inventors: Tianan Tim MA, San Diego, CA (US); Su-Lin LOW, San Diego, CA (US); Hausting HONG, San Diego, CA (US); Hong Kui YANG, San Diego, CA (US)

(21) Appl. No.: 17/877,669

(22) Filed: Jul. 29, 2022

Related U.S. Application Data
(63) Continuation of application No. PCT/IB2020/058655, filed on Sep. 17, 2020.
(60) Provisional application No. 62/968,467, filed on Jan. 31, 2020.

(51) Int. Cl. G06F 9/48; G06F 9/54; G06F 9/50

(52) U.S. Cl. CPC G06F 9/4881; G06F 9/544; G06F 9/5016; G06F 9/5022

(57) ABSTRACT

Introduced here are insertion schemes in which queues can be branched into one or more sub-queues for more effective management of queuing elements. Often, a computing device will have a primary buffer into which queuing elements are populated for execution by a processor. However, the amount of contiguous memory space allocated for the primary buffer may be fixed. To address this, a queue manager may insert indicators that link to secondary buffers into the primary buffer in order to expand the number of effective entries in the primary buffer.

### CROSS-REFERENCE TO RELATED APPLICATIONS

This application is a continuation of International Patent Application No. PCT/IB2020/058655, filed on Sep. 17, 2020, which claims the benefit of priority to U.S. Provisional Application No. 62/968,467, filed on Jan. 31, 2020, the contents of which are hereby incorporated by reference in their entireties.

### BACKGROUND

Generally, a wireless network system has two communication paths—an uplink path and a downlink path. When data is transmitted from a base station (e.g., a cell site) to a computing device along the downlink path, packets are received by the computing device and then processed in accordance with a protocol stack. The term “protocol stack” refers to the software implementation of a suite of communication protocols by the computing device. Individual protocols within a suite may be designed with a single purpose in mind; however, because each protocol usually communicates with at least one other protocol, the protocols are normally imagined as layers in a stack. In the protocol stack, the lowest layer is responsible for interacting with the underlying hardware while each layer further up in the stack adds additional capabilities.

One example of a protocol stack is the Evolved Universal Mobile Telecommunications System (UMTS) Terrestrial Radio Access (E-UTRA) protocol stack that was developed for Long Term Evolution (LTE). As shown in FIG. 1, the E-UTRA protocol stack includes a medium access control (MAC) layer, a radio link control (RLC) layer), and a packet data convergence protocol (PDCP) layer. The MAC layer controls the physical hardware that is responsible for interacting with the transport channels of the transmission medium. The RLC layer resides above the MAC layer but beneath the PDCP layer and, as such, acts as an interface between the MAC and PDCP layers. Some of the main functions of the RLC layer are segmentation of upper-layer service data units (SDUs) into RLC protocol data units (PDUs) and desegmentation (also referred to as “concatenation”) of lower-level PDUs into RLC SDUs.

### SUMMARY

Various embodiments concern approaches to nesting sub-queues within queues to permit more effective management of elements queued for execution.

Introduced here are approaches in which queues can be branched into one or more sub-queues for more effective management of information units and tasks. Assume, for example, that a queue manager determines that a new queuing element should be executed before an existing queuing element that was previously populated in an entry of a primary buffer. In such a scenario, the queue manager may store the existing queuing element to a storage space and then insert a special queuing element in the entry that, when executed, routes the processor to a secondary buffer. Then, the queue manager may populate the new queuing element and the existing queuing element into the secondary buffer in such a manner that the processor will execute the new queuing element before executing the existing queuing element.

Sub-queues could also be used to expand the available capacity of a primary buffer into which queuing elements are populated for execution by a processor. For example, in some embodiments, the queue manager is configured to monitor available capacity of the primary buffer. Upon determining that the available capacity of the primary buffer has fallen beneath a threshold, the queue manager may insert a special queuing element into the primary buffer that, when executed, routes the processor to a secondary buffer in which queuing elements can be populated.

### BRIEF DESCRIPTION OF THE DRAWINGS

FIG. 1 depicts a portion of the E-UTRA protocol stack developed for LTE.

FIG. 2 includes a high-level block diagram that illustrates how a queue manager can implement an insertion scheme to manage a primary queue buffer (or simply “primary buffer”).

FIG. 3 illustrates how insertion indicators can be used to nest queues within one another to expand the number of effective entries in a primary buffer.

FIG. 4 illustrates how a queuing element (QE) is formatted in some embodiments.

FIG. 5 illustrates how not empty (NE) indicators for queues (or groups of queues) can be consolidated into a hierarchical bitmap that may be used by a queue manager.

FIG. 6 illustrates how overflow (OF) indicators for queues (or groups of queues) can be consolidated into a hierarchical bitmap that may be used by a queue manager.

FIG. 7 illustrates how underflow (UF) indicators for queues (or groups of queues) can be consolidated into a hierarchical bitmap that may be used by a queue manager.

FIG. 8 illustrates an example of a data structure in which timers (and, more specifically, timer identifiers) are associated with threshold durations.

FIG. 9 illustrates an example of a data structure in which information/statistics related to a queue can be stored.

FIG. 10 illustrates an example of a data structure that is representative of an ordered list of primary buffers that are managed by a queue manager.

FIG. 11 depicts a flow diagram of a process in which a bounded, existing queuing element in the primary buffer is replaced with a special queuing element that includes an insertion indicator for a secondary buffer.

FIG. 12 depicts a flow diagram of another process in which an existing queuing element in the primary buffer is replaced with a special queuing element that includes an insertion indicator for a secondary buffer.

FIG. 13 includes a high-level block diagram of a queue manager that is implemented on a computing device.

FIG. 14 includes a high-level block diagram that illustrates an example of a computing system in which at least some operations described herein can be implemented.

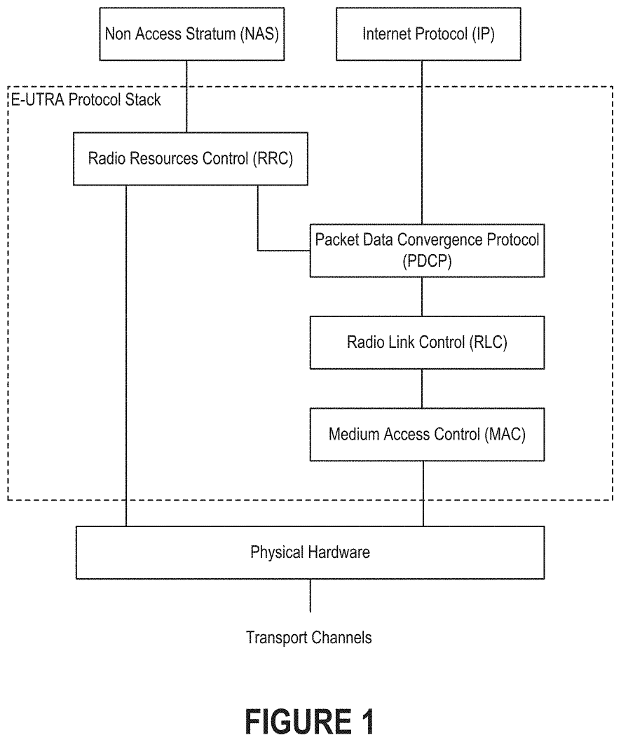

Various features of the technologies described herein will become more apparent to those skilled in the art from a study of the Detailed Description in conjunction with the drawings. Embodiments are illustrated by way of example and not limitation in the drawings, in which like references may indicate similar elements. While the drawings depict various embodiments for the purpose of illustration, those skilled in the art will recognize that alternative embodiments may be employed without departing from the principles of the technologies. Accordingly, while specific embodiments are shown in the drawings, the technology is amenable to various modifications.

### DETAILED DESCRIPTION

In MAC layers, like those in the protocol suites for 4G and 5G wireless communication standards, a single information unit or a single processing task (or simply “task”) will frequently have to branch into multiple sub-units or sub-tasks. For instance, this may occur when segmentation or desegmentation is performed. Several software-implemented approaches have been developed in an attempt to process sub-units and sub-tasks more efficiently. However, there are notable downsides to these software-implemented approaches. For example, these software-implemented approaches consume a relatively high amount of power due to the additional computation that is involved and require more data buffers (or simply “buffers”) in which to temporarily store the sub-units or sub-tasks. Moreover, performance of these software-implemented approaches tends to be quite slow, and therefore may result in significant delays.

To accelerate the processing of sub-units and sub-tasks, more effective control of the underlying hardware is needed. Introduced here, therefore, are approaches in which queues can be branched into one or more sub-queues for more effective management of information units and tasks. For the purpose of illustration, embodiments may be described in the context of queuing elements that are loaded into entries in queues for processing. The terms “queuing element” and “element,” as used herein, may refer to a sub-task, sub-unit, or any other piece of information that needs to be processed.

As further discussed below, the present disclosure is directed to hardware-implemented approaches for branching a main queue (or simply “queue”) into one or more sub-queues into which queuing elements can be populated. These approaches may be useful in designing acceleration engines that are configured for segmentation to, or desegmentation from, the RLC layer, as well as implementing segmentation and desegmentation protocols. As an example, a single RLC PDU may be split into multiple RLC PDU segments that are populated into a sub-queue, or multiple PLC PDU segments in a sub-queue may be concatenated into a single RLC PDU.

Embodiments may be described with reference to particular types of network technologies, protocol stacks, processes, etc. However, those skilled in the art will recognize that these features are similarly applicable to other types of network technologies, protocol stacks, etc. For example, while embodiments may be described in the context of the LTE protocol stack, features of these embodiments could be extended to protocol stacks developed for 4G/5G network technologies. As another example, while the approaches described herein may be described in the context of preventing overflow, features of these approaches could also be used to ensure that a certain action (e.g., retransmission of packets) needs to occur by a certain point of an already scheduled queue.

Aspects of the technology can be embodied using special-purpose hardware (e.g., circuitry), programmable circuitry programmed with software and/or firmware, or a combination of special-purpose hardware and programmable circuitry. Accordingly, embodiments may include a machine-readable medium with instructions that, when executed, cause a computing device to perform a process in which a special queuing element is inserted into a queue that, when read, points to control information for a sub-queue. Entries can be populated in the sub-queue for processing. Moreover, the control information may include a return pointer that indicates where to return in the queue after all entries in the sub-queue have been processed.

### Terminology

References in this description to “an embodiment” or “one embodiment” means that the particular feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the words “comprise” and “comprising” are to be construed in an inclusive sense rather than an exclusive or exhaustive sense (i.e., in the sense of “including but not limited to”). The term “based on” is also to be construed in an inclusive sense rather than an exclusive or exhaustive sense. Thus, unless otherwise noted, the term “based on” is intended to mean “based at least in part on.”

The terms “connected,” “coupled,” or any variant thereof is intended to include any connection or coupling between two or more elements, either direct or indirect. The connection/coupling can be physical, logical, or a combination thereof. For example, objects may be electrically or communicatively coupled to one another despite not sharing a physical connection.

When used in reference to a list of multiple items, the word “or” is intended to cover all of the following interpretations: any of the items in the list, all of the items in the list, and any combination of items in the list.

The sequences of steps performed in any of the processes described here are exemplary. However, unless contrary to physical possibility, the steps may be performed in various sequences and combinations. For example, steps could be added to, or removed from, the processes described here. Similarly, steps could be replaced or reordered. Thus, descriptions of any processes are intended to be open-ended.

Overview of Insertion Scheme

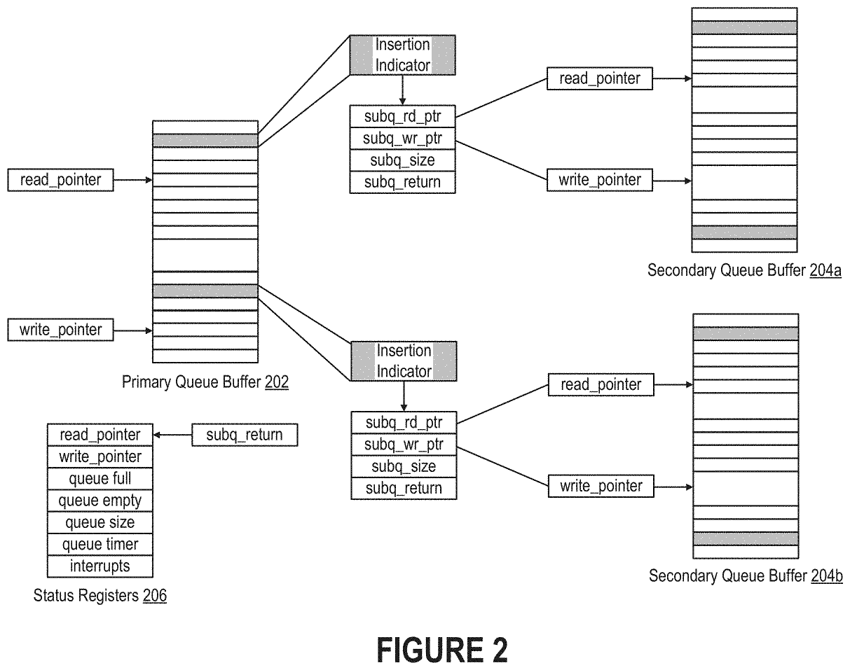

FIG. 2 includes a high-level block diagram that illustrates how a queue manager can implement an insertion scheme to manage a primary queue buffer 202 (or simply “primary buffer”). For the purpose of illustration, the insertion scheme will be described in the context of a single primary buffer (also referred to as a “main buffer”). However, those skilled in the art will recognize that the queue manager may be responsible for managing any number of primary buffers.

The primary buffer 202 can be any region of physical memory storage in which data can be temporarily stored. For example, the primary buffer 202 may be a circular buffer (also referred to as a “cyclic buffer” or “ring buffer”) that is representative of a data structure that uses a buffer of fixed size as if it were connected end-to-end. A circular buffer is a bounded queue with separate indices (write_pointer, read_pointer) for inserting and removing data. As such, the indices will simply continue working through the bounded queue as if the buffer is contiguous in nature. Such a data structure lends itself to buffering streams of data since individual queuing elements do not need to be shuffled when one is consumed. When the read pointer reads a queuing element in an entry in a circular buffer, the read pointer can simply progress to the next entry in the circular buffer. In contrast, if the primary buffer 202 were a non-circular buffer, then it would be necessary to shift all queuing elements when one is consumed. In protocol stacks suitable for 4G/5G network technologies, the primary buffer 202 may be used as a queue for incoming traffic following flow classifications, or the primary buffer 202 may be used as a queue for quality of service (QoS) traffic after QoS classifications.

As shown in FIG. 2, the primary buffer 202 may have status registers 206 that can be used as control parameters by the queue manager. These status registers 206 include the read and write pointers, control indicators (also referred to as “control flags”) that may indicate whether the queue is completely full, whether the queue is completely empty, or the size of the queue, and associated interrupts for controlling central processing units (CPUs) (also referred to as “processors”). These status registers are further discussed below with reference to FIGS. 5-8. The read and write pointers can be updated as queuing elements in the primary buffer 202 are being enqueued and dequeued. Each entry in the primary buffer 202 may be capable of temporarily storing a queuing element that contains information regarding a task or object. For example, a queuing element may be a descriptor for a packet or a command for operating a piece of hardware.

The queuing elements may be stored in a contiguous memory space such that multiple queuing elements can be dequeued at once. For example, multiple queuing elements may be dequeued at once if execution of one queuing element depends on the outcome of execution of the preceding queuing element. Storing queuing elements in a contiguous memory space (e.g., a circular buffer) improves operational efficiency of the bus to which the queue manager is communicatively connected and avoids excessive delays due to latencies in accessing system data. This also makes control schemes easier for hardware to implement. However, one issue with conventional control schemes is that the hardware-implemented buffers exist in a contiguous memory space that makes it difficult to insert anything between adjacent queuing elements. If a new queuing element needs to be added to a primary buffer at a certain location in the queue (e.g., between a pair of existing queuing elements), there is no straightforward way to do this effectively with conventional control schemes.

Introduced here is an insertion scheme that addresses this issue. Assume that the primary buffer 202 includes a sequence of queuing elements that are stored in contiguous memory space allocated for the queue. Moreover, assume that each entry is of identical size and consistent format. To implement the insertion scheme, a queue manager can insert a special queuing element in which a field is defined to be an “insertion indicator,” which is actually a pointer to a storage space where control information for a sub-queue may be stored.

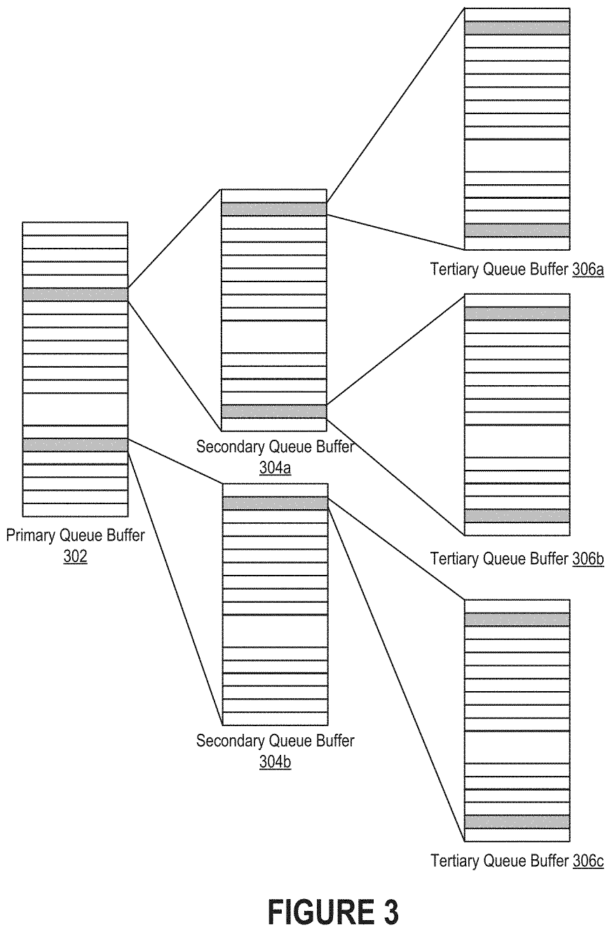

In FIG. 2, there are two sub-queues that are referred to as secondary queue buffers 204a-b (or simply “secondary buffers”). Each secondary buffer 204a-b may resemble the primary buffer 202 in its basic features. For example, each secondary buffer 204a-b may have its own set of read and write pointers and other status registers for control information such as size, type, etc. However, each secondary buffer 204a-b may also have a unique piece of information defined in the control information, namely, a return pointer (subq_return). The return pointer indicates where the sub-queue will return to. If the return pointer points to the control information of the primary buffer 202, then the sub-queue will return to the primary buffer 202 when all queuing elements in the sub-queue are exhaustively processed. Alternatively, the return pointer may point to the control information of another sub-queue, as further discussed below with reference to FIG. 3. Thus, insertion indicators can be used to nest sub-queues within the primary buffer 202 without limit.

Insertion indicators may also be used to expand the primary buffer 202 if capacity of the primary buffer 202 exceeds a threshold. For instance, insertion indicators may be used to ensure that the primary buffer 202 does not run out of its allocated memory space. As an example, if the queue manager determines that the write pointer is in danger of overwriting an existing queuing element in the primary buffer 202, then the queue manager can delete the most recently populated queuing element from the primary buffer 202, insert an insertion indicator to expand the amount of available memory space, and then cause the deleted queuing element to be written into the secondary buffer that is pointed to by the insertion indicator.

FIG. 3 illustrates how insertion indicators can be used to nest queues within one another to expand the number of effective entries in a primary buffer 302. In FIG. 3, two insertion indicators have been inserted into the queue of the primary buffer 302. Each of these insertion indicators points to a different secondary queue buffer 304a-b (or simply “secondary buffer”). Two insertion indicators have been inserted into the queue of one secondary buffer (i.e., secondary buffer 304a), while one insertion indicator has been inserted into the queue of the other secondary buffer (i.e., secondary buffer 304b). Each of these insertion indicators points to a different tertiary queue buffer 306a-c (or simply “tertiary buffer”). The terms “primary,” “secondary,” and “tertiary” have been used to illustrate that the main queue may have different nest levels of sub-queues. Those skilled in the art will recognize that the insertion scheme described herein could be used to insert any number of sub-queues along any number of levels. Accordingly, while embodiments may be described in the context of “secondary buffers” for a “primary buffer,” those features are similarly applicable to “tertiary buffers” for “secondary buffers.”

Before queuing elements are inserted into a sub-queue (e.g., one of the secondary buffers 304a-b or tertiary buffers 306a-c), the queue manager may initially organize those queuing elements. For example, assume that the queue manager is interested in adding queuing element(s) to the primary buffer 302 in a desired location. In the primary buffer 302 at the location where those queuing element(s) are to be added, two different situations can occur. First, a secondary buffer may replace a queuing element in the primary buffer 302 at the location. In this situation, the queue manager changes the queuing element in the primary buffer 302 to a special queuing element that includes an insertion indicator, which points to the control information of the secondary buffer. Second, a secondary buffer may be inserted before a regular queuing element in the primary buffer 302. In this situation, the regular queuing element is saved to a storage space (e.g., a register) and then replaced with a special queuing element that includes an insertion indicator. This insertion indicator will point to the control information of the secondary buffer that is to be inserted into the primary buffer 302. Then, the regular queuing element can be populated into the secondary buffer. Where the regular queuing element is populated in the secondary buffer may depend on the order in which the queue manager wants queuing elements to be processed. For example, the regular queuing element may be populated at the end of the secondary buffer so that execution occurs immediately before reverting back to the primary buffer 302. In some embodiments, the queue manager is configured to dynamically increase the size of the secondary buffer (e.g., by one queuing element) to account for the saved queuing element copied over from the primary buffer 302. After the special queuing element has been inserted into the primary buffer 302, the control and statistical information for the primary buffer 302 may be updated as further discussed below.

To execute these operations, the queue manager can implement a special command to incorporate the secondary buffer. This special command may be different than the normal enqueue and dequeue commands. The special command may define the entry point in the primary buffer 302 and the special queuing element which is to be inserted. Moreover, this special command may instruct the queue manager to update the statistics for the primary buffer 302 with additional information about the secondary buffer to which the special element points.

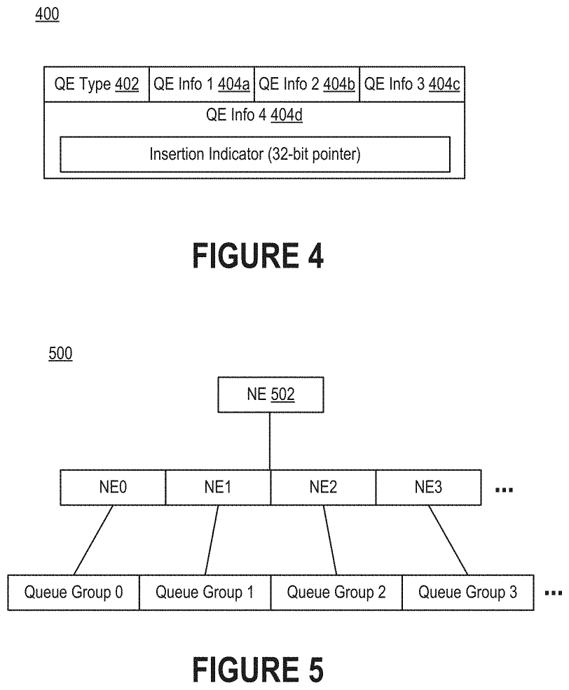

FIG. 4 illustrates how a queuing element (QE) 400 is formatted in some embodiments. In this example format, there are various fields for different types of information. For example, the queuing element 400 includes a type field 402 that specifies the type, namely, whether the queuing element 400 is a normal queuing element (also referred to as a “regular queuing element”) or a special queuing element. If the type field 402 indicates that the queuing element 400 is a special queuing element, one of the other fields will serve as the pointer to the control information for the corresponding sub-queue. For instance, the last 32 bits of one of the information fields 404a-d may include an insertion indicator that points to the storage space where the control information for the corresponding sub-queue is stored. Here, for example, the insertion indicator is included in the information field labeled “QE Info 4.”

FIG. 5 illustrates how not empty (NE) indicators for queues (or groups of queues) can be consolidated into a hierarchical bitmap 500 that may be used by a queue manager. The main NE indicator 502 indicates to the queue manager whether any queues managed by the queue manager are not empty.

In some embodiments, the queue manager is responsible for managing a set of primary buffers. In such embodiments, the main NE indicator 502 will indicate not empty so long as at least one of the primary buffers is not empty. Note, however, that some of these primary buffers may have secondary buffers nested therein as discussed above. To account for the secondary buffers, the hierarchical bitmap 500 can indicate which groups of queues are not empty. Here, for example, NE0 is the NE indicator for Queue Group 0, and it acts as a logical OR operator for all queues in Queue Group 0. Queue Group 0 may be representative of a single queue (e.g., a primary buffer), or Queue Group 0 may be representative of multiple queues (e.g., a primary buffer and one or more secondary buffers). Accordingly, NE0 will indicate that that Queue Group 0 is not empty so long as one of the queues in Queue Group 0 is not empty. NE1, NE2, and NE3 are the NE indicators for Queue Group 1, Queue Group 2, and Queue Group 3, respectively. Note that the number of queues in each group need not necessarily be the same.

The main NE indicator 502 may act as a logical OR operator for all of the queue groups. Accordingly, the main NE indicator 502 may indicate not empty if any of the NE indicators for the queue groups indicate not empty. The level of hierarchy and granularity of the queues/groups may be highly programmable.

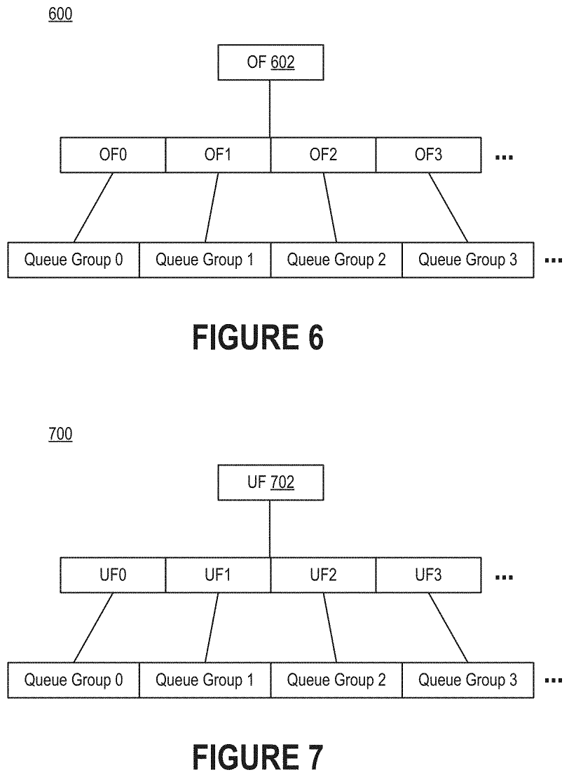

FIG. 6 illustrates how overflow (OF) indicators for queues (or groups of queues) can be consolidated into a hierarchical bitmap 600 that may be used by a queue manager. The main OF indicator 602 indicates to the queue manager whether any queues managed by the queue manager are experiencing overflow. The term “overflow,” as used herein, refers to the write event that occurs when a queue is full. If the queue is a circular buffer, then overflow may result in an existing queuing element being overwritten by the write pointer with a new queuing element.

In some embodiments, the queue manager is responsible for managing a set of primary buffers. In such embodiments, the main OF indicator 602 will indicate overflow so long as at least one of the primary buffers is full. Much like hierarchical bitmap 500 of FIG. 5, the queue manager can use hierarchical bitmap 600 of FIG. 6 to indicate which queues (or groups of queues) are overflowing. Here, for example, OF0 is the OF indicator for Queue Group 0, and it acts as a logical OR operator for all queues in Queue Group 0. Queue Group 0 may be representative of a single queue (e.g., a primary buffer), or Queue Group 0 may be representative of multiple queues (e.g., a primary buffer and one or more secondary buffers). Accordingly, OF0 will indicate that that Queue Group 0 is overflowing if any of the queues in Queue Group 0 are overflowing. OF1, OF2, and OF3 are the OF indicators for Queue Group 1, Queue Group 2, and Queue Group 3, respectively. Note that the number of queues in each group need not necessarily be the same.

The main OF indicator 602 may act as a logical OR operator for all of the queue groups. Accordingly, the main OF indicator 602 may indicate overflowing if any of the OF indicators for the queue groups indicate overflowing. The level of hierarchy and granularity of the queues/groups may be highly programmable.

FIG. 7 illustrates how underflow (UF) indicators for queues (or groups of queues) can be consolidated into a hierarchical bitmap 700 that may be used by a queue manager. The main UF indicator 702 may indicate to the queue manager whether any queues managed by the queue manager are experiencing underflow. The term “underflow,” as used herein, refers to the read event that occurs when a queue is empty. Thus, underflow will occur only when a queue is completely devoid of queuing elements.

In some embodiments, the queue manager is responsible for managing a set of primary buffers. In such embodiments, the main UF indicator 702 will indicate overflow if any of the primary buffers are experiencing underflow (i.e., are empty). Much like hierarchical bitmaps 500, 600 of FIGS. 5-6, the queue manager can use hierarchical bitmap 700 of FIG. 7 to indicate which queues (or groups of queues) are underflowing. Here, for example, UF0 is the UF indicator for Queue Group 0, and it acts as a logical OR operator for all queues in Queue Group 0. Queue Group 0 may be representative of a single queue (e.g., a primary buffer), or Queue Group 0 may be representative of multiple queues (e.g., a primary buffer and one or more secondary buffers). Accordingly, UF0 will indicate that that Queue Group 0 is underflowing if any of the queues in Queue Group 0 are underflowing. UF1, UF2, and UF3 are the UF indicators for Queue Group 1, Queue Group 2, and Queue Group 3, respectively. Note that the number of queues in each group need not necessarily be the same.

The main UF indicator 702 may act as a logical OR operator for all of the queue groups. Accordingly, the main UF indicator 702 may indicate underflowing if any of the UF indicators for the queue groups indicate underflowing. The level of hierarchy and granularity of the queues/groups may be highly programmable.

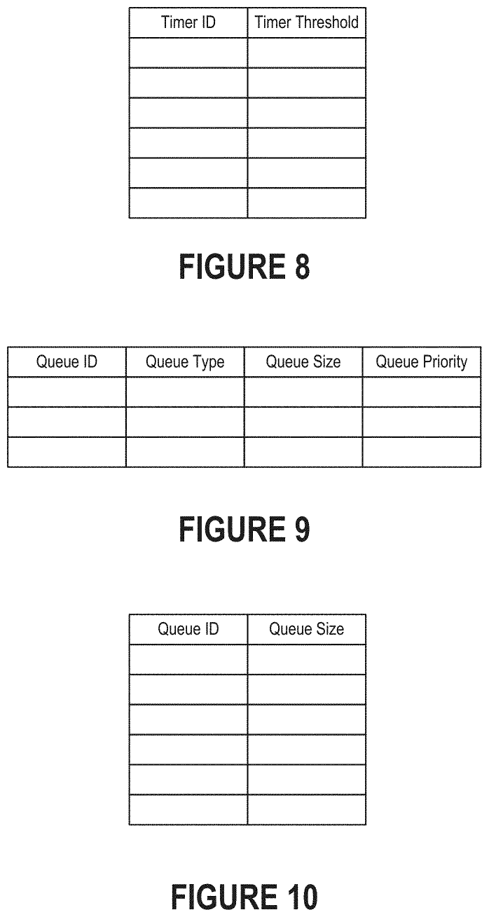

Each queue managed by a queue manager may be associated with a set of timers to indicate timeout events. FIG. 8 illustrates an example of a data structure in which timers (and, more specifically, timer identifiers) are associated with threshold durations. Timers can be used to indicate a timeout exception occurred, and thus a certain time limit has been violated, when operating on the queues described above. The timers may be count-down timers or count-up timers that are configured to generate an interrupt upon expiring.

Queue information and statistics may be maintained in data structures (e.g., tables) that are readily searchable using, for example, queue identifiers. FIG. 9 illustrates an example of a data structure in which information/statistics related to a queue can be stored. A queue identifier may uniquely identify the corresponding queue from amongst all queues managed by a queue manager, from amongst all queues included in a computing device, etc. Generally, each primary buffer is associated with a different queue identifier, and information/statistics related to each primary buffer can be associated with the corresponding queue identifier. In FIG. 9, for example, each row in the table is associated with a different queue.

As mentioned above, the queue manager may be responsible for ensuring that the information/statistics associated with each primary buffer are updated if any secondary buffers are nested therein. Thus, the data structure may be updated whenever a secondary buffer is added or removed by the queue manager. These data structures can be stored in a memory and made accessible to software and/or firmware executing on the computing device of which the queue manager is a part. As shown in FIG. 9, the data structure can include information/statistics such as queue size, queue type, queue priority, and the like.

In some embodiments, the queue manager is configured to automatically sort the primary buffers that it is responsible for managing according to size. Thus, the queue manager may generate a list of primary buffers that is ordered from largest to smallest, or vice versa. Said another way, the queue manager may sort the list of primary buffers in ascending or descending order, so the first entry may be either the largest or smallest queue depending on the configured order. FIG. 10 illustrates an example of a data structure that is representative of an ordered list of primary buffers that are managed by a queue manager. As shown in FIG. 10, each primary buffer may be identified in the data structure by its queue identifier, which allows the ordered list to be easily retrieved from a memory.

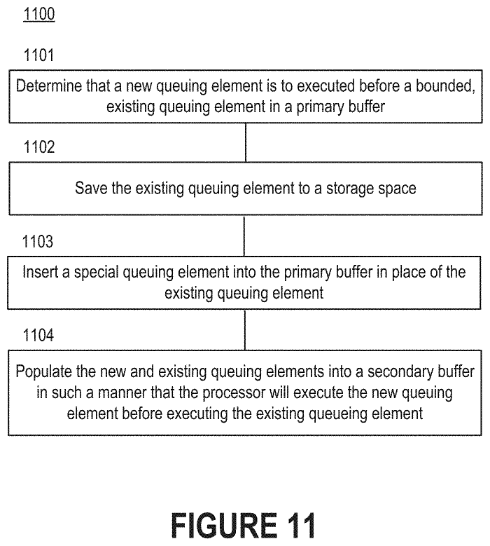

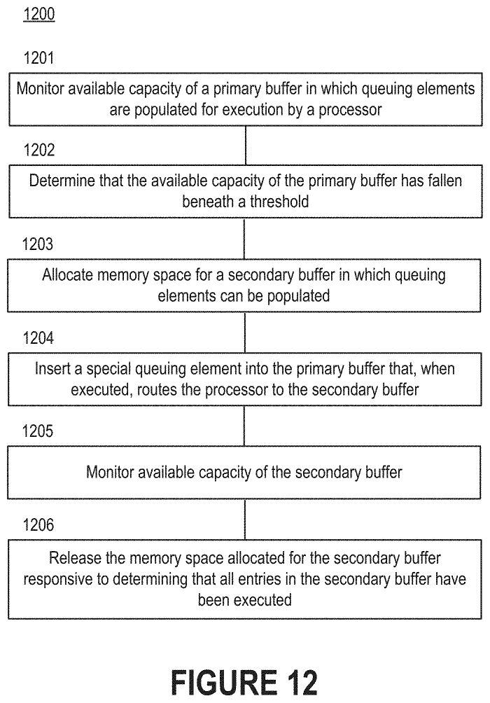

As discussed above, there are at least two situations in which an insertion scheme may be implemented by a queue manager. These situations are discussed with respect to FIGS. 11-12.

First, the queue manager may opt to replace a bounded, existing queuing element in the primary buffer with a secondary buffer. In this situation, the queue manager needs to change the bounded, existing queuing element to a special queuing element that, when executed, routes the processor to the secondary buffer. The term “bounded,” as used herein, refers to an existing queuing element that is preceded and followed by existing queuing elements. When an existing queuing element is bounded, inserting a new queuing element can prove to be difficult since multiple existing queuing elements may need to be rearranged.

FIG. 11 depicts a flow diagram of a process 1100 in which a bounded, existing queuing element in the primary buffer is replaced with a special queuing element that includes an insertion indicator for a secondary buffer. Initially, a queue manager will determine that a new queuing element is to be executed before a bounded, existing queuing element in the primary buffer (step 1101). As an example, assume that a primary buffer includes five queuing elements to be executed, and the queuing manager has determined that a new queuing element should be executed after the third queuing element but before the fourth queuing element. In such a scenario, the second, third, and fourth queuing elements are “bounded.”

Rather than rearrange multiple queuing elements, the queue manager can save the bounded, existing queuing element to a storage space (step 1102). For example, the queue manager may temporarily save the bounded, existing queuing element to a register. Then, the queue manager can insert the special queuing element into the primary buffer in place of the bounded, existing queuing element (step 1103). More specifically, the queue manager can cause the special queuing element to be written in the same entry in the primary buffer such that the bounded, existing queuing element is overwritten. As discussed above, the special queuing element may include an insertion indicator that, when executed, routes the processor to the secondary buffer.

Thereafter, the queue manager can populate the new queuing element and the existing queuing element into the secondary buffer in such a manner that the processor will execute the new queuing element before executing the existing queuing element (step 1104). Where the new queuing element and the existing queuing element are populated into the secondary buffer may depend on the order in which the queue manager wants those queuing elements to be executed. For example, the existing queuing element may be populated into the last entry of the secondary buffer so that execution occurs immediately before redirection of the processor from the secondary buffer to the primary buffer. As another example, the new queuing element may be populated into the first entry of the secondary buffer so that execution occurs immediately after redirection of the processor from the primary buffer to the secondary buffer.

For the purpose of illustration, refer again to the above-mentioned example where the primary buffer includes five queuing elements to be executed and the queuing manager has determined that a new queuing element should be executed after the third queuing element but before the fourth queuing element. In this scenario, the queue manager can temporarily save the fourth queuing element to a storage space (e.g., a register), insert a special queuing element in place of the fourth queuing element, and then populate the new queuing element and the fourth queuing element into a secondary buffer. The new queuing element can be populated into any entry in the secondary buffer that is above the fourth queuing element. For example, the new queuing element may be populated into the first entry in the secondary buffer while the fourth queuing element may be populated into the second entry in the secondary buffer, or the new queuing element may be populated into the first entry in the secondary buffer while the fourth queuing element may be populated into the last entry in the secondary buffer.

Alternatively, the queue manager may populate the existing queuing element directly into the secondary buffer rather than into the storage space as discussed above with reference to step 1102. In such embodiments, the queue manager may populate the existing queuing element directly into a predetermined entry in the secondary buffer responsive to determining that a new queuing element should be executed before the existing queuing element. The predetermined entry could be, for example, the first entry or the last entry in the secondary buffer.

In some embodiments, the queue manager is configured to increase the size of the secondary buffer to account for inclusion of the existing queuing element copied over from the primary buffer. For example, the queue manager may dynamically increase the size of the secondary buffer by one entry to account for the existing queuing element. Moreover, as discussed above, information regarding the primary buffer may be maintained (e.g., in a register) in some embodiments. In such embodiments, the queue manager may ensure that the information is updated to account for nesting of the secondary buffer within the primary buffer.

Second, the queue manager may opt to insert a secondary buffer before an existing queuing element to avoid overwriting (e.g., due to overflow). In this situation, the queue manager needs to replace the existing queuing element with a special queuing element that, when executed, routes the processor to the secondary buffer.

FIG. 12 depicts a flow diagram of another process 1200 in which an existing queuing element in the primary buffer is replaced with a special queuing element that includes an insertion indicator for a secondary buffer. Initially, a queue manager can monitor available capacity of a primary buffer in which queuing elements are populated for execution by a processor (step 1201). While monitoring the available capacity, the queue manager may determine that the available capacity of the primary buffer has fallen beneath a predetermined threshold (step 1202). For example, the queue manager may continually examine an overflow (OF) indicator associated with the primary buffer to discover when all entries in the primary buffer have been populated. As another example, the queue manager may continually examine the primary buffer itself to establish when one or zero entries are unfilled.

Then, the queue manager can allocate memory space for a secondary buffer in which queuing elements can be populated (step 1203) and insert a special queuing element into the primary buffer that, when executed, routes the processor to the secondary buffer (step 1204). More specifically, the queue manager may identify the existing queuing element that was most recently populated into the primary buffer, save the existing queuing element to a storage space (e.g., a register), and then populate the existing queuing element into the secondary buffer. Thus, the queue manager may copy the most recently populated queuing element from the primary buffer into the secondary buffer to expand the number of effective entries in the primary buffer. Generally, the existing queuing element is populated into the first entry of the secondary buffer. However, the existing queuing element could be populated into another entry of the secondary buffer.

As discussed above with respect to step 1203, memory space may be allocated for the secondary buffer when needed. However, when the secondary buffer is no longer needed, the queue manager may wish to release the previously allocated memory space. Said another way, since the secondary buffer is intended to be temporarily used for overflow, the queue manager may wish to release the memory space allocated for the secondary buffer responsive to determining that overflow is no longer an issue. Thus, the queue manager may monitor available capacity of the secondary buffer (step 1205). For example, the queue manager may continually examine either an underflow (UF) indicator or a not empty (NE) indicator associated with the secondary buffer. If the queue manager determines that at least one entry in the secondary buffer has not been executed, then the queue manager may not take further action. However, if the queue manager determines that all entries in the secondary buffer have been executed, then the queue manager may release the memory space that was allocated for the secondary buffer (step 1206). Accordingly, the queue manager may be able to dynamically allocate and release memory space depending on the number of secondary buffers needed over time.

The steps of these processes may be performed in various sequences. For example, steps 1203 and 1205-1206 of FIG. 12 may be included in process 1100 of FIG. 11. Other steps may also be included in some embodiments.

There are several alternative approaches to those described herein.

One alternative involves copying all queuing elements beneath the location where the new queuing element is to be inserted. For example, assume that a new queuing element is to be inserted into a primary buffer that includes five queuing elements contiguously arranged in the queue. If the queue manager determines that the new queuing element should be arranged above the second queuing element, then the queue manager may copy the second, third, fourth, and fifth queuing elements (e.g., for inclusion in the secondary buffer). But this approach is computationally complicated, slow, and power intensive.

Another alternative involves representing each queue as a memory block of contiguous lists. Such an approach allows an entire queue to be represented as a linked list of memory blocks. To add to the list at any point, the queue manager could simply create another link in the linked list of memory blocks. While this approach is relatively straightforward, to insert in the middle of a memory block, the queue manager would have to break the memory block into two memory blocks and then insert the new memory block therebetween.

Alternatively, the queue manager could employ the insertion schemes described herein. This alternative offers several advantages, namely, (1) it permits a tradeoff between performance and flexibility on the contiguous memory block sizes and (2) if a linked list of memory blocks is released, the list can deallocate the released memory blocks easily and rechain the list. Accordingly, this approach offers efficient space allocation/deallocation since free memory block regions can collapse when deallocated back to the pool. A disadvantage of this approach is that contiguous lists of memory blocks tend to be difficult for hardware to handle. At a high level, a simple memory block makes normal enqueue and dequeue operations more complicated, and thus circular buffers tend to be much more efficient for hardware-implemented queuing operations.

Overview of Queue Manager

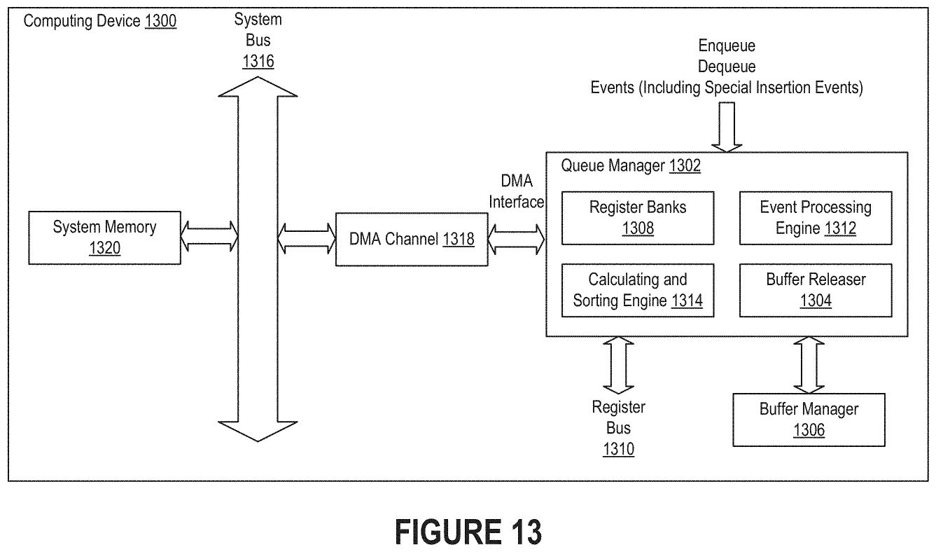

FIG. 13 includes a high-level block diagram of a queue manager 1302 that is implemented on a computing device 1300. Under normal operations, buffer spaces will initially be created by the queue manager 1302 since the number of primary buffers (and the size of those primary buffers) is known. Once sub-queues are added to the primary buffers, however, the buffer spaces may be dynamically allocated and then released by a buffer releaser 1304. The allocation of buffers may be based on external actions when the sub-queues are constructed. After a sub-queue is finished, the queue manager 1302 may be responsible for releasing the corresponding buffer back to the buffer releaser 1304 via a buffer manager 1306.

The queue manager 1302 may maintain register banks 1308 for some or all control registers. For example, the queue manager 1302 may maintain a separate register bank (e.g., registers 206 of FIG. 2) for each queue, though the information included in the register bank may depend on whether the queue is representative of a primary buffer or a secondary buffer. These register banks 1308 may be programmed through a register bus 1310 that is communicatively connected to the queue manager 1302.

The event processing engine 1312 may be responsible for enqueuing and dequeuing elements, including special elements with insertion indicators, into the buffers allocated by the buffer releaser 1304. In some embodiments, the queue manager 1302 further includes a dedicated module for calculating statistics, sorting queues, etc. This dedicated module, which may be referred to as the “calculating and sorting engine 1314,” can be implemented via hardware, firmware, software, or any combination thereof. As discussed above, the buffer releaser 1304 may be responsible for interacting with the buffer manager 1306 to allocate buffers when necessary and/or release buffers after the queues are finished.

In some embodiments, the queue manager 1302 is communicatively connected to a system bus 1316 via a Direct Memory Access (DMA) channel 1318. Such a design may only be necessary when the queues are shared with software that is executing in the system memory 1320 of the computing device 1300, though this is commonly how queue managers are used.

Benefits of Insertion Scheme

Several benefits can be obtained by employing the insertion schemes described herein. These benefits include

Lower power consumption due to efficient operations of hardware-implemented queues;

Improved processing speed due to the higher speed at which hardware-implemented queues can be processed in comparison to entirely software-implemented queues;

Flexible and efficient management of lists in hardware design; and

Flexible and efficient usage of memory (e.g., additional memory for sub-queues can be added/removed dynamically as those sub-queues are added/removed).

These benefits may be particularly useful to portable computing devices (also referred to as “mobile computing devices”) such as mobile phones, routers, etc. For instance, the insertion scheme may be used in high-performance, low-cost, and/or low-power modems designed for 4G/5G network technologies (also referred to as “4G modems” or “5G modems”).

Computing System

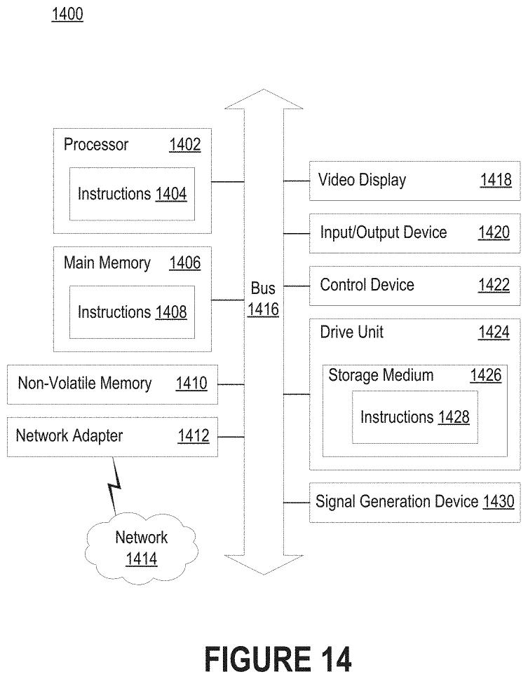

FIG. 14 includes a high-level block diagram that illustrates an example of a computing system 1400 in which a queue manager can be implemented. Thus, components of the computing system 1100 may be hosted on a computing device (e.g., computing device 1300 of FIG. 13) that includes a queue manager (e.g., queue manager 1302 of FIG. 13).

The computing system 1400 may include a processor 1402, main memory 1406, non-volatile memory 1410, network adapter 1412 (e.g., a network interface), video display 1418, input/output device 1420, control device 1422 (e.g., a keyboard, pointing device, or mechanical input such as a button), drive unit 1424 that includes a storage medium 1426, and signal generation device 1430 that are communicatively connected to a bus 1416. The bus 4116 is illustrated as an abstraction that represents one or more physical buses and/or point-to-point connections that are connected by appropriate bridges, adapters, or controllers. The bus 1416, therefore, can include a system bus, Peripheral Component Interconnect (PCI) bus, PCI-Express bus, HyperTransport bus, Industry Standard Architecture (ISA) bus, Small Computer System Interface (SCSI) bus, Universal Serial Bus (USB), Inter-Integrated Circuit (I2C) bus, or bus compliant with Institute of Electrical and Electronics Engineers (IEEE) Standard 1394.

The computing system 1400 may share a similar computer processor architecture as that of a server, router, desktop computer, tablet computer, mobile phone, video game console, wearable electronic device (e.g., a watch or fitness tracker), network-connected (“smart”) device (e.g., a television or home assistant device), augmented or virtual reality system (e.g., a head-mounted display), or another electronic device capable of executing a set of instructions (sequential or otherwise) that specify action(s) to be taken by the processing system 1400.

While the main memory 1406, non-volatile memory 1410, and storage medium 1424 are shown to be a single medium, the terms “storage medium” and “machine-readable medium” should be taken to include a single medium or multiple media that stores one or more sets of instructions 1426. The terms “storage medium” and “machine-readable medium” should also be taken to include any medium that is capable of storing, encoding, or carrying a set of instructions for execution by the processing system 1400.

In general, the routines executed to implement the embodiments of the present disclosure may be implemented as part of an operating system or a specific application, component, program, object, module, or sequence of instructions (collectively referred to as “computer programs”). The computer programs typically comprise one or more instructions (e.g., instructions 1404, 1408, 1428) set at various times in various memories and storage devices in a computing device. When read and executed by the processor 1402, the instructions cause the computing system 1400 to perform operations to execute various aspects of the present disclosure.

While embodiments have been described in the context of fully functioning computing devices, those skilled in the art will appreciate that the various embodiments are capable of being distributed as a program product in a variety of forms. The present disclosure applies regardless of the particular type of machine- or computer-readable medium used to actually cause the distribution. Further examples of machine- and computer-readable media include recordable-type media such as volatile and non-volatile memory devices 1410, removable disks, hard disk drives, optical disks (e.g., Compact Disk Read-Only Memory (CD-ROMS) and Digital Versatile Disks (DVDs)), cloud-based storage, and transmission-type media such as digital and analog communication links.

The network adapter 1412 enables the computing system 1400 to mediate data in a network 1414 with an entity that is external to the computing system 1400 through any communication protocol supported by the computing system 1400 and the external entity. The network adapter 1412 can include a network adaptor card, a wireless network interface card, a switch, a protocol converter, a gateway, a bridge, a hub, a receiver, a repeater, or a transceiver that includes an integrated circuit (e.g., enabling communication over Bluetooth® or Wi-Fi®).

The techniques introduced here can be implemented using software, firmware, hardware, or a combination of such forms. For example, aspects of the present disclosure may be implemented using special-purpose hardwired (i.e., non-programmable) circuitry in the form of application-specific integrated circuits (ASICs), programmable logic devices (PLDs), field-programmable gate arrays (FPGAs), and the like.

Remarks

The foregoing description of various embodiments has been provided for the purposes of illustration. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes various embodiments, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A method for managing a primary buffer into which queuing elements are populated for execution by a processor, the method comprising:
determining a new queuing element is to be executed before an existing queuing element that was previously populated in an entry of the primary buffer;
saving the existing queuing element to a storage space;
inserting a special queuing element in the entry that, when executed, routes the processor to a secondary buffer; and
populating the new queuing element and the existing queuing element into the secondary buffer in such a manner that the processor will execute the new queuing element before executing the existing queuing element.

2. The method of claim 1, wherein the existing queuing element is populated into a last entry of the secondary buffer so that execution occurs immediately before redirection of the processor from the secondary buffer to the primary buffer.

3. The method of claim 1, wherein the new queuing element is populated into a first entry of the secondary buffer so that execution occurs immediately after redirection of the processor from the primary buffer to the secondary buffer.

4. The method of claim 1, wherein the primary buffer is a circular buffer having a fixed size.

5. The method of claim 1, further comprising:
increasing a size of the secondary buffer by one entry to account for inclusion of the existing queuing element.

6. The method of claim 1, wherein the special queuing element further routes the processor to information regarding the secondary buffer.

7. The method of claim 1, further comprising:
updating, in response to said populating, information regarding the primary buffer that is maintained in a register to account for nesting of the secondary buffer within the primary buffer.

8. A method comprising:
monitoring available capacity of a primary buffer into which queuing elements are populated for execution by a processor;
determining that the available capacity of the primary buffer has fallen beneath a predetermined threshold; and
inserting a special queuing element into the primary buffer that, when executed, routes the processor to a secondary buffer in which queuing elements can be populated.

9. The method of claim 8, wherein said inserting is performed responsive to determining that all entries in the primary buffer have been populated with queuing elements.

10. The method of claim 9, further comprising:
identifying a queuing element that was most recently populated into an entry in the primary buffer;
saving the queuing element to a storage space; and
populating the queuing element in the secondary buffer.

11. The method of claim 10, wherein the queuing element is populated into a first entry of the secondary buffer.

12. The method of claim 10, wherein the special queuing element is inserted into the entry in the primary buffer in place of the queuing element copied into the secondary buffer.

13. The method of claim 8, wherein said monitoring comprises continually examining an overflow (OF) indicator associated with the primary buffer.

14. The method of claim 8, wherein the special queuing element further routes the processor to information regarding the secondary buffer that comprises a return pointer that defines where to return following execution of all queuing elements in the secondary buffer.

15. The method of claim 8, further comprising:
monitoring available capacity of the secondary buffer; and
releasing memory space that was allocated for the secondary buffer responsive to determining that all entries in the secondary buffer have been executed by the processor.

16. The method of claim 15, wherein said monitoring comprises continually examining either an underflow (UF) indicator or a not empty (NE) indicator associated with the secondary buffer.

17. The method of claim 8, further comprising:
allocating, responsive to said determining, memory space for the secondary buffer.

18. A system comprising:
a processor configured to execute a queue manager that manages a primary buffer into which queuing elements are populated for execution by the processor; and
a memory having instructions stored thereon that, when executed, cause the queue manager to:
monitor available capacity of the primary buffer on a continual basis,
allocate memory space for a secondary buffer responsive to determining that all entries in the primary buffer have been populated with queuing elements,
identify a queuing element that was most recently populated into the primary buffer, save the queuing element to a storage space,
insert a first special queuing element into the primary buffer in place of the saved queuing element,
wherein when executed, the first special queuing element routes the processor to the secondary buffer, and
populate the saved queuing element into the secondary buffer.

19. The system of claim 18, wherein the secondary buffer is accompanied by information that specifies where to return following execution of all queuing elements in the secondary buffer.

20. The system of claim 18, wherein the secondary buffer comprises a second special queuing element that, when executed, routes the processor to a tertiary buffer.
